(19) United States
(12) Patent Application Publication
(10) Pub. No.: US 2022/0183507 A1
(43) Pub. Date: Jun. 16, 2022

(54) EDYSpro Milk Frother

(71) Applicants: Artur Petrosyan, Finglas Road (IE); Aneta Kyrova, Finglas Road (IE)

(72) Inventors: Artur Petrosyan, Finglas Road (IE); Aneta Kyrova, Finglas Road (IE)

(21) Appl. No.: 17/120,275

(22) Filed: Dec. 14, 2020

(51) Int. Cl. A47J 43/08; A47J 43/044; B01F 3/04; B01F 7/00; B01F 13/00; B01F 15/00

(52) U.S. Cl. CPC A47J 43/082; A47J 43/044; B01F 3/04531; B01F 7/00158; B01F 7/00583; B01F 2215/0014; B01F 15/00538; B01F 7/00633; A47J 2043/04427; B01F 2003/04872; B01F 2015/00636; B01F 13/002

(57) ABSTRACT

The present invention relates to a milk frother assembly which makes the two stirrers rotate forward and reverse respectively, by using the reversing drive mechanism, rotating rod one, rotating rod two, a carabiner and two stirrers, so as to achieve the advantage of more efficient milk frothing and controlling of the quality of milk bubbles. The assembly allows through its novel setting of the length adjustment mechanism, to manually slide the slide plate, then move the rotating rod two through the sleeve and the connecting rod, and then adjust the position of the inner stirrer head, which is suitable for making milk froth in various capacities.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention relates to a technical field of household appliances, specifically a double-headed milk frother.

### Description of the Related Art

A milk frother is a machine commonly used with coffee machines to make milk froth. With the popularization of coffee, adding milk froth to liquid products can make the taste and appearance better, thus it is no surprise that milk frothers are particularly favoured by cappuccino or latte milk coffee enthusiasts.

At present, there are generally two ways to make milk froth on the market. One is to use a pot mixer to make milk froth, and the other is with a hand-held mixer. Both the above devices use a single mixing head for mixing. In the actual use process, the contact of the milk froth during the whisking process is not sufficient, which causes the time for making milk froth to be longer, and the effect and the quality of the milk froth are not ideal due to the fixed position of the stirring head of the whisker.

There are multiple inventions that have been found in prior art providing advancements in similar field. For instance, a Milk frother bearing British patent 2,486,872A is issued to Alex Gort-Barten. The patent is on a milk frother comprises a chamber 1 for receiving milk or a milk based liquid, drive means 2 adapted to drive a whisk 3, which whisk is adapted to rotate in the milk or milk based liquid to mix the milk or milk based liquid and to produce foam. The frother further comprises heating means 4 adapted to heat the milk or milk based liquid, wherein the frother is provided with an electronic control unit adapted to independently control the drive means and the heating means such that the heating means can be switched off a predetermined time before the drive means. The frother may also comprise fins 5, 6 and may also be provided with an interlock to ensure that it only operates when a lid is in the closed position.

Another patent on Milk frother appliance bearing U.S. Pat. No. 1,058,8450B2 is issued to Qbo Coffee GmbH. The patent is on an appliance for preparing frothed milk is dockable onto a drinks preparation machine and, for this purpose, includes at least one connection for steam produced by the drinks preparation machine, as well as an interface for electrical current supplied by the drinks preparation machine. The appliance also includes a milk frothing unit with a gear pump. The gear pump at an inlet side is connected to a milk feed conduit and to an air feed. The milk frothing unit is configured such that an operating parameter is adjustable in a manner depending on a measured value and/or on a user input.

Another patent on Milk frother bearing worldwide patent 2,012,076848A1 is issued to Alex Gort-Barten. The patent is on a milk frother comprising a chamber 1 for receiving milk or a milk based liquid, drive means 2 adapted to drive a whisk 3, which whisk is adapted to rotate in the milk or milk based liquid to mix the milk or milk based liquid and to produce foam, the frother further comprising heating means 4 adapted to heat the milk or milk based liquid, wherein the frother is provided with an electronic control unit adapted to independently control the drive means and the heating means such that the heating means can be switched off a predetermined time before the drive means.

Another patent on Milk Frother bearing US patent 2,009,0087532A1 is issued to Cafina AG. The patent proposes a milk frother including a milk feed conduit (2), a pump (5) for forwarding the milk, at least one means for heating the milk, as well as a blender element (1) for blending the milk with the frothing medium. The milk is first heated and then air is jetted into the milk. After this, the milk/air blend is fed to a blending section of the blender element (1) where it is multiply deflected and/or decombined to generate high-quality milk froth.

Another British patent 2,498,965A on Milk frother comprising vessel with a spout for pouring liquid milk and a spout for pouring frothed milk is issued to Morphy Richards Ltd. The patent is on a milk frother 700 comprises a vessel 703 for containing milk and a lid (706, FIG. 7) which closes off the upper end of the vessel. Internally, the vessel is divided into first 800 and second 801 compartments by a screen 802, which allows liquid milk to drain from a first outlet 707, and frothed and/or liquid milk to drain from a second outlet 708. Preferably the outlets are spouts, wherein the second spout 708 is larger than the first 707. The vessel may connect to a base platform (701, FIG. 7) for cordless operation. In another aspect, a vane member 809 protrudes into an internal compartment of the vessel for folding frothed milk back in on itself. The screen 802 may have a mesh with aperture size configured for allowing milk to drain through the mesh whilst preventing frothed milk from passing through. The milk frother may have an agitator (1002, FIG. 10) for agitating milk in the vessel and a heating member for heating the milk.

A Steam milk frother bearing US patent 2,020,0163486A1 is issued to Sandora Household Electric Appliances (shenzhen) Ltd. The patent is on a steam milk frother, the steam milk frother arranges a steam control valve, to control a flow of the steam entering the injection pipe, being able to better control forming small and dense milk foams in the beverage. The steam milk frother, on one hand, is able to form small and dense milk foams in the beverage stably, making the beverage feel delicate and dense, improving the taste of the beverage; on other hand, owns a simple and quick operation, and it is needed only open a switch, and put the injection pipe into the liquid, before forming small and dense milk foams in the liquid, without a need to manually add air or adjust an angle of the injection tube.

There are multiple advancements that have been presented in prior art. However, these solutions are limited and restricted to their conventional systems. As a result of intensive studies on the above problems, the present inventor has found that the prior problems can be solved by a novel method which provides a double-headed milk frother, which can manually change the position of the mixing head by sliding it up and down, and both mixing heads can be rotated simultaneously (one in the forward direction, the other in the reverse direction), which can accelerate the production rate of milk froth, and thus better control the efficiency and quality of milk frothing.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of a simplest and most efficient double-headed milk frother.

It is also the primary objective of the invention to provide specifically method of providing a double-headed milk frother, which can rotate both mixing heads simultaneously (one in the forward direction, the other in the reverse direction), so as to make milk froth more efficiently and control the quality of milk bubbles, and thereby solving the problems raised by the above-mentioned background technology.

It is another objective of the invention to provide a utility model which makes the two stirrers rotate forward and reverse respectively, by using the reversing drive mechanism, rotating rod one, rotating rod two, a carabiner and two stirrers, so as to achieve the advantage of more efficient milk frothing and controlling of the quality of milk bubbles.

Another object of the present invention is to provide an assembly where through the setting of the length adjustment mechanism, the utility model enables the user to manually slide the slide plate, then move the rotating rod two through the sleeve and the connecting rod, and then adjust the position of the inner stirrer head, which is suitable for making milk froth in various capacities.

It is further the objective of the invention to provide an advancement where the milk doesn't spills out as compared to the normal milk frother which spills the milk out of the container at a high speed due to heads which turn in the same direction and thus adding the speed of the milk without providing effective frothing.

It is also the objective of the invention to provide a milk frother that is easier to use but more closely replicates the performance of an espresso machine.

It is further object of the present invention is to provide an assembly which is easy to use, hold and clean.

It is also the objective of the invention to provide a smart assembly which provide ease of use and convenience to the user and provides multiple functionalities to the user.

It is also the objective of the invention to provide an efficient and easy assembly which is cost effective and convenient.

Thus, it is the objective to provide an advancement in a milk frother assembly. Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

FIG. 1 is a three-dimensional structural diagram of the double-headed milk frother utility model.

FIG. 2 is a schematic cross-sectional view diagram of the local structure of the utility model.

FIG. 3 is a schematic diagram of the partial connection structure of the utility model sleeve and connecting rod.

In the diagrams: 1, housing; 2, motor; 3, rotating rod one; 4, rotating rod two; 5, clasp; 6, stirring head; 7, short toothed roller; 8, long toothed roller; 9, gear two; 10, length adjustment mechanism; 101, sleeve; 102, connecting rod; 103, sliding groove; 104, slide plate; 11, mounting ring; 12, battery; 13, gear one.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention provides a novel method of a double-headed milk frother, which can rotate both mixing heads simultaneously (one in the forward direction, the other in the reverse direction), so as to make milk froth more efficiently and control the quality of milk bubbles, and thereby solving the problems raised by the above-mentioned background technology.

In order to achieve the above-mentioned purpose, the utility model provides the following technical solutions: a double-headed milk frother, comprising a housing; the inner part of the housing is equipped with a motor; the output shaft of the motor has a fixed connection with a rotating rod one; the surface of the rotating rod one is equipped with a rotating rod two; the surface of the rotating rod one and the rotating rod two are both clamped with clasps; the outer wall of the clasps has a fixed connection with a stirrer head; the rotating rod one and the rotating rod two are equipped with a reversing drive mechanism; the surface of the rotating rod two is equipped with a length adjustment mechanism. As per further embodiments the assembly allows regular frothing whisks turn in the same direction makes the milk turn in the same way too. This movement prevents the milk from frothing effectively because it loses speed on its way.

Preferably, the reversing drive mechanism comprises a gear one coupled to the surface of the rotating rod one; a number of mounting rings with a fixed connection to the inner wall of the housing; a short-toothed roller and a long-toothed roller rotating between the two mounting rings; the short-toothed roller meshing with the gear one and the long-toothed roller, respectively, and a gear two coupled to the surface of the rotating rod two; the gear two meshing with the long-toothed roller.

Preferably, the length adjustment mechanism comprises a bearing which is coupled to the surface of the rotating rod two, and the surface of the bearing has a fixed connection with a sleeve, and the sleeve has a fixed connection with a connection rod on one side, and a sliding groove is arranged in the outer wall of the housing, and the inner wall of the slide and has a shock dampened connection with a slide plate, and the outer wall of the connection rod has a fixed connection with the slide plate.

Preferably, the inner wall of the three mounting rings located on the left side has a fixed connection with a battery.

The following is a clear and complete description of the technical scheme in the utility model embodiment with the drawings in the utility model embodiment, and it is obvious that the described embodiment is only a part of the embodiment of the utility model, but not the entire embodiment. Based on the embodiment of the utility model, all other embodiments obtained by ordinary technicians in the field without creative labour belong to the scope of protection of the utility model.

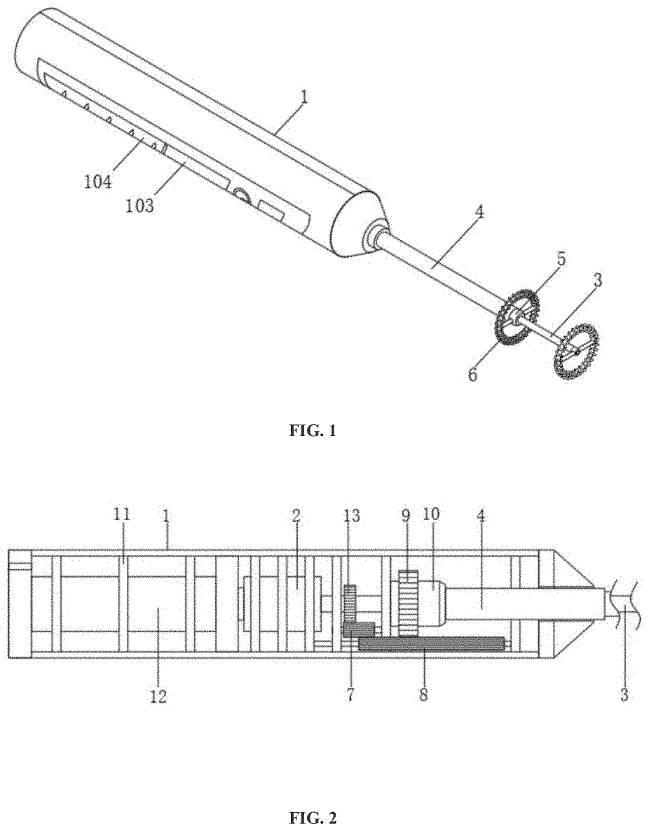

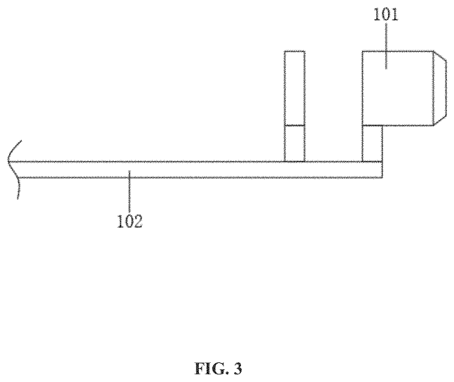

As shown in FIG. 1 to FIG. 3, the utility model provides a double-headed milk frother, including a housing 1; a motor 2 is provided inside the housing 1; the surface of the motor 2 has a fixed connection to three mounting rings 11; and the motor 2 is connected to the battery 12 by a unidirectional electrical connection; the output shaft of the motor 2 has a fixed connection to a rotating rod one 3; the surface of the rotating rod one 3 is equipped with a rotating rod two 4; the surface of the rotating rod one 3 and the rotating rod two 4 are both clamped with a clasp 5; the outer wall of the clasp 5 has a fixed connection to a mixing head 6; a reversing drive mechanism is provided between the rotating rod one 3 and the rotating rod two 4; and the surface of the rotating rod two 4 is equipped with a length adjustment mechanism 10.

As shown in FIG. 2, the reversing drive mechanism includes a gear one 13 connected to the surface of the rotating rod one 3; a number of mounting rings 11 with a fixed connection to the inner wall of the housing 1; a short-toothed roller 7 and a long-toothed roller 8 rotating between the two mounting rings 11; the short-toothed roller 7 meshing with the gear one 13 and the long-toothed roller 8, respectively; and a gear two 9 connected to the surface of the rotating rod two 4; the gear two 9 meshing with the long-toothed roller 8.

As shown in FIG. 1 to FIG. 3, the length adjustment mechanism 10 includes a bearing that is connected to the surface of the rotating rod two 4, and the surface of the bearing has a fixed connection to the sleeve 101, and the connection rod 102 has a fixed connection to one side of the sleeve 101, and the outer wall of the housing 1 is opened with a sliding groove 103, and the inner wall of the sliding groove 103 is shock dampened and connected to the slide 104, and the outer wall of the connection rod 102 has a fixed connection to the slide 104.

As shown in FIG. 2, the battery 12 has a fixed connection to the inner wall of the three mounting rings 11 on the left side of the housing 1; the left side of the housing 1 is clamped with a base, and the base is provided with a USB charging interface on one side; the USB charging interface is connected to the battery 12 in one direction; the outer wall of the housing 1 is provided with a switch and a display screen; the switch is connected to the motor 2 in one direction; the switch can control the rotational speed of the motor 2 to control the speed of rotation of the two mixing heads 6; the battery is connected to the display screen in one direction, and the display screen can display the remaining battery charge through the settings.

The specific use of the utility model is divided into the following steps:

Step 1: Charge the battery 12 through the USB charging port; at this time the display will show the power status of the milk frother; after the completion of charging, hold the milk frother and put it into the container with milk.

Step 2: Adjust the distance between the two mixing heads 6 according to the amount of milk; at this time the user pushes the slide plate 104 to sliding groove 103, so that the slide plate 104 is moving through the connecting rod 102 and the sleeve 101, and then the rotating rod two 4 drives the outer mixing head 6 to move, so as to achieve the effect of mixing a variety of milk foam volumes. This feature helps to move the whisk while in the frothing process too in order to eliminate extra hand movement for the user and creating better foam quality for the milk.

Step 3: Start the motor 2 with the switch, and the motor 2 drives the rotation of the rotating rod one 3, and the rotating rod one 3 drives the rotation of the gear one 13, which in turn drives the rotation of the gear two 9 and the gear one 13 in the opposite direction through the use of the short-toothed roller 7 and the long-toothed roller 8, and the long-toothed roller 8 ensures that when the mixing head 6 is adjusted in step 2, the gear two 9 always remains engaged with the long-toothed roller 8, which ensures that the mixing head 6 always rotates, and then the rotating rod two 4 located on the surface of the rotating rod one 3 can rotate in the opposite direction with the rotating rod one 3, which ensures the efficiency of milk froth and can improve the quality of milk froth.

The assembly as per its further embodiments includes the mentioned process where washing the double whisk head using washing liquid is done. Then an ON/OFF power button can be used by the user and the whisks will start to turn in opposite direction on low speed and start to make foam. The top whisk turns left and the bottom whisk is turns right.

An ON/OFF power button can be again used to choose desired speed from low to medium and high speed in turn. The speed power will be displayed on the screen. The frothing button is operated manually by sliding up and down. This button will then accordingly move the whisks close or far from each other.

The Position-I as per its additional embodiments allows to whisk close to each other where it is the main position and the frother will always return back to this after use due to its installed spring. This position is also recommended for frothing milk where micro-foam thick, creamy and shiny foam with small bubbles is desired. Such as milk for espresso-based coffee drinks, particularly those with latte art or milkshakes

The position 2 is whisks far from each other which allows to move the frothing button manually up and down for loose foam with visible large bubbles preferred for drinks such as cappuccino. The Long press of the ON/OFF power button will turn the frother off while working at low or medium speed.

The cleaning as per its further embodiments can be achieved by immersing the whisks and the metal part of the frother head into the water and press the ON/OFF power button for a few seconds. It is also advisable not to immerse the main body in the water.

The charging of assembly can be achieved with built in battery, which is easy to charge by USB cable. The USB power source with the micro USB charging cable included to charge the device when it runs out of power.

The installation instruction includes holding the plastic part of the whisk head with thumb and index finger to install it onto the milk frother main body or remove it from the main body. Furthermore, it is recommended not to hold the metal bar of the whisk head during installation. Otherwise it may bend the bar which may lead to over-vibration of the whisk head when you turn it on.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I: A universal eco-friendly and an ergonomic design of a double-headed milk frother, comprising a housing (1);
the housing (1) is equipped with a motor (2), characterized in that: the output shaft of the motor (2) has a fixed connection to a rotating rod one (3); the rotating rod one (3) is equipped with a rotating rod two (4) on the surface; the rotating rod one (3) and the rotating rod two (4) are clamped on the surface with a clasp (5); a mixing head (6) has a fixed connection to the outer wall of the clasp (5); a reversing drive mechanism is provided between the rotating rod one (3) and the rotating rod two (4), and a length adjusting mechanism (10) is provided on the surface of the rotating rod two (4).

II: A kind of double-headed milk frother according to claim 1, characterized in that: the reversing drive mechanism includes a gear one (13), which is attached to the surface of the rotating rod one (3); the inner wall of the housing (1) has a fixed connection with a number of mounting rings (11); the two mounting rings (11) are rotationally connected with a short-toothed roller (7) and a long-toothed roller (8); the short-toothed roller (7) is separately meshed with the gear one (13) and the long-toothed roller (8); and the surface of the rotating rod two (4) is sleeved by a gear two (9), and the gear two (9) is meshed with the long toothed roller (8).

III: A double-headed milk frother according to claim 1, characterized in that: the length adjustment mechanism (10) includes a bearing sleeve connected to the surface of the rotating rod two (4), and the surface of the bearing has a fixed connection with a sleeve (101), the sleeve (101) has a fixed connection with a connecting rod (102) on one side; the outer wall of the housing (1) is provided with a sliding groove (103); the inner wall of the sliding groove (103) has a shock dampened connection with a sliding plate (104), and the outer wall of the connecting rod (102) has a fixed connection to the sliding plate (104).

IV: A double-headed frother according to claim 1, characterized in that a battery (12) has a fixed connection to the inner wall of three mounting rings (11) located on the left side.

V: A double-headed milk frother according to claim 1, characterized in that the position of the hand-operated mixing heads can be slid up and down, and the two mixing heads can be rotated at the same time (one in the forward direction, the other in the reverse direction), which can speed up the milk frothing rate, so as to better control the efficiency and quality of milk frothing.

VI: A double-headed milk frother according to claim 1, characterized in that pressing the on/off power button and selecting the desired speed from low to medium and high speed, and the speed level will be displayed on the LCD screen.

VII: A double-headed milk frother according to claim 1, characterized in that the position of the mixing head can be manually operated by sliding up and down, and this button will move the upper and lower stirring heads of the milk frother accordingly, allowing them to get closer to or further away from each other, so as to better control the efficiency and quality of milk frothing. (Micro-foam with small bubbles is produced when the upper and lower mixing heads (close to each other) are rotated in the opposite direction; loose foam with large bubbles is produced when the upper and lower mixing heads (far from each other) are rotated in the opposite direction).

VIII: A double-headed milk frother according to claim 1, characterized in that: when operating at low or medium speed, pressing and holding the ON/OFF power button will turn off the frother.
